(19) United States
(12) Patent Application Publication
(10) Pub. No.: US 2024/0190512 A1
(43) Pub. Date: Jun. 13, 2024

(54) VEHICLE-BODY FRONT STRUCTURE

(71) Applicant: SUBARU CORPORATION, Tokyo (JP)

(72) Inventor: Akihiro MAEDA, Tokyo (JP)

(21) Appl. No.: 18/508,584

(22) Filed: Nov. 14, 2023

(30) Foreign Application Priority Data
Dec. 9, 2022 (JP) 2022-197516 A

(51) Int. Cl. B62D 25/08

(52) U.S. Cl. CPC B62D 25/088

(57) ABSTRACT

A vehicle-body front structure includes a bulkhead front, a toe board, and a strut tower. The bulkhead front extends vehicle-widthwise, receives water droplets, and guides the water droplets to an outside in a vehicle width direction. The toe board extends vehicle-widthwise on a vehicle front side of a vehicle compartment and separates the vehicle compartment from a vehicle-body front part where a front-wheel suspension is accommodated. The strut tower is constituted by members joined to each other and supports the front-wheel suspension. The bulkhead front includes a vehicle-widthwise outer part having a first drainage port. The first drainage port communicates with a drainage channel in a closed cross section defined by the bulkhead front, the toe board, and the members constituting the strut tower. The drainage channel has, on its vehicle lower side, a second drainage port opened toward a wheel house where a tire is housed.

### CROSS-REFERENCE TO RELATED APPLICATIONS

The present application claims priority from Japanese Patent Application No. 2022-197516 filed on Dec. 9, 2022, the entire contents of which are hereby incorporated by reference.

### BACKGROUND

The disclosure relates to a vehicle-body front structure. In general, a vehicle-body front part of, for example, an automobile accommodates, for example, a frame structure, a drive unit, or a suspension and a strut tower. The frame structure is a framework for maintaining rigidity of a vehicle front part. The drive unit is, for example, an internal combustion engine or a drive motor. The suspension supports a front wheel. The strut tower supports the suspension.

Along with travel of the vehicle, the strut tower is subjected through the wheel and the like to transmission of loads in a twisting direction, a vehicle up-down direction, and the like. Thus, the strut tower is sought to have rigidity capable of withstanding large loads transmitted from the suspension in order to improve steering stability, riding quality, safety, and the like of the vehicle.

On the other hand, a cowl top panel is disposed on a vehicle upper side of the strut tower. The cowl top panel receives water droplets of rainwater and the like from a windshield and discharges the water droplets to the outside of the vehicle. Then, a drainage channel is secured around the strut tower in order to ensure drainage of rainwater and the like. However, in response to the transition from an internal-combustion engine vehicle to an electric vehicle, the vehicle-body front part is sought to make its space small in order to secure a space for accommodating electric components and the like.

In response to the above-described requests, for example, Japanese Unexamined Patent Application Publication (JP-A) No. 2016-117370 discloses a technique related to the following structure. The structure includes a cowl front panel, a dash side panel, a cowl box, a strut tower, and an extension panel. The cowl front panel is attached to a dash panel delimiting an engine room and extends forward of a vehicle. The dash side panel extends forward of the vehicle from a lateral side of the dash panel. The cowl box is defined by the dash panel, the cowl front panel, and a cowl side panel. The strut tower supports a suspension below the cowl box and defines a drainage channel together with the dash panel and the dash side panel. The extension panel extends from the strut tower to the cowl front panel and constitutes a route from the cowl box to the drainage channel.

### SUMMARY

An aspect of the disclosure provides a vehicle-body front structure for a vehicle. The vehicle-body front structure includes a bulkhead front, a toe board, and a strut tower. The bulkhead front extends in a vehicle width direction of the vehicle, is configured to receive water droplets from a portion of the vehicle including a windshield of the vehicle, and is configured to guide the water droplets to an outside in the vehicle width direction. The toe board extends in the vehicle width direction on a vehicle front side of a vehicle compartment of the vehicle and separates the vehicle compartment from a vehicle-body front part of the vehicle in which a front-wheel suspension is accommodated. The strut tower is constituted by members joined to each other and configured to support the front-wheel suspension. The bulkhead front includes a vehicle-widthwise outer part having a first drainage port. The first drainage port communicates with a drainage channel provided in a closed cross section defined by the bulkhead front, the toe board, and the members constituting the strut tower. The drainage channel has, on a vehicle lower side of the drainage channel, a second drainage port opened toward a wheel house in which a tire is housed.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a top perspective view of a vehicle-body front structure according to an embodiment of the disclosure;

FIG. 2 is an enlarged top perspective view of an area AA illustrated in FIG. 1;

FIG. 3 is a top perspective view of the area AA illustrated in FIG. 2, illustrating a bracket front suspension lower in a see-through manner;

FIG. 4 is a front cross-sectional view taken along line B-B of FIG. 3, illustrating a drainage route for rainwater and the like in FIG. 3;

FIG. 5 is a front cross-sectional view taken along line B-B of FIG. 3, illustrating an entry route for the rainwater and the like in FIG. 3; and

FIG. 6 is a top perspective view of the area AA illustrated in FIG. 2, illustrating the bracket front suspension lower in a see-through manner and illustrating load propagation from a strut tower.

### DETAILED DESCRIPTION

The technique described in JP-A No. 2016-117370 involves providing the extension panel in order to secure a drainage route and to increase the rigidity of the strut tower. Additionally, the technique has a problem that, when rainwater and the like flow backward from the outside through a drainage port, the rainwater and the like may spurt out through the drainage port, resulting in obstruction of a visual field of an occupant. Then, the technique has a problem that the rainwater and the like flowing backward may be scattered inside an engine room, and thus may enter a vehicle compartment through a vent hole that is provided in the engine room and communicates with the vehicle compartment.

It is desirable to provide a vehicle-body front structure that achieves a drainage channel configuration maintaining rigidity of a strut tower and prevents entry of rainwater and the like from the outside through a drainage channel.

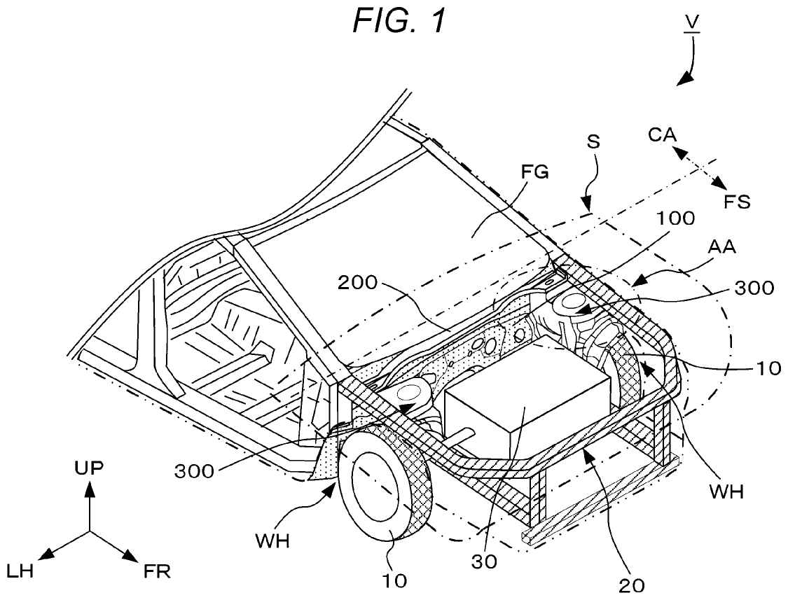

Hereinafter, with reference to FIGS. 1 to 6, a vehicle-body front structure S according to an embodiment will be described. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. Note that, arrow FR, arrow UP, and arrow LH, which are illustrated as appropriate in the drawings, point to a front side (front), an upper side in a front view, and a left side in a front view, respectively, of a vehicle V to which the vehicle-body front structure S is attached. Additionally, in the following description, unless otherwise specified, an up-down direction, a front-rear direction, and a left-right direction refer to an up-down direction in a front view, a front-rear direction in a front view, and a left-right direction in a front view, respectively, of the vehicle V.

The vehicle V is, for example, an electric vehicle including a power unit as a drive source. Note that, the vehicle V may be, for example, a vehicle including an internal combustion engine or may be a hybrid electric vehicle including, as drive sources, the internal combustion engine and the power unit.

### Embodiment

With reference to FIGS. 1 to 3, a description will be given of a configuration of the vehicle-body front structure S, according to the present embodiment, included in the vehicle V.

### Configuration of Vehicle-Body Front Structure S

The vehicle-body front structure S has a bilaterally symmetrical configuration in a vehicle width direction.

As illustrated in FIG. 1, the vehicle-body front structure S includes front wheels 10, a frame structure 20, a power unit 30, a toe board 100, a bulkhead front 200, and strut towers 300. Wheel houses WH, which are spaces where tires are housed, are provided on vehicle-widthwise outer sides with respect to the strut towers 300. Additionally, a windshield FG is disposed on a vehicle rear upper side of the bulkhead front 200.

The frame structure 20 is a framework for maintaining rigidity of a vehicle-body front part, and is disposed around the periphery of a vehicle-body front part FS in the vehicle-body front structure S. In the frame structure 20, steel materials each formed of a member such as a highly rigid metal and having a closed cross section are provided in each of a vehicle up-down direction and a vehicle front-rear direction, and the steel materials are joined to each other by welding or the like.

The power unit 30 is a drive apparatus including a motor, a transmission, a clutch, a drive shaft, and the like (which are not illustrated) that drive the front wheels 10. The power unit 30 is mounted on and fixed to the frame structure 20 while being surrounded by the frame structure 20.

### Toe Board 100

The toe board 100 is a partition wall that extends in the vehicle width direction on a vehicle front side of a cabin CA, and that separates the cabin CA from the vehicle-body front part FS in which front-wheel suspensions and the like are accommodated. In one embodiment, the cabin CA may serve as a “vehicle compartment”. The toe board 100 is provided upright in the vehicle up-down direction on the vehicle front side of the cabin CA, and is joined to the frame structure 20 by welding or the like. Additionally, a portion of a vehicle front-side surface of the toe board 100 constitutes a closed cross section CS constituting a drainage structure DS to be described later.

### Bulkhead Front 200

The bulkhead front 200 extends in the vehicle width direction on a vehicle upper front side of the toe board 100. The windshield FG is disposed on the vehicle rear upper side of the bulkhead front 200. The bulkhead front 200 is formed of a member such as a steel plate and is joined to the toe board 100 by welding or the like.

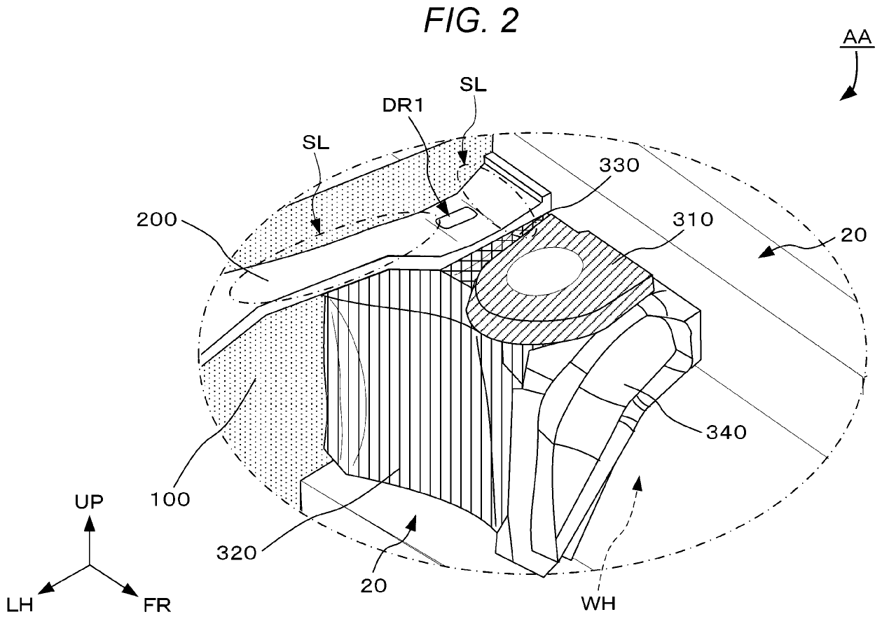

As illustrated in FIG. 2, the bulkhead front 200 includes vehicle-widthwise opposite outer parts each having a drainage port DR1 as a first drainage port formed into a substantially rectangular shape and opened to penetrate the bulkhead front 200 in the vehicle up-down direction. The bulkhead front 200 includes vehicle-widthwise opposite ends that are each bent toward the vehicle upper side into an L shape in a front view. On the vehicle upper side of the bulkhead front 200, a cowl top panel (not illustrated) is disposed so as to cover the bulkhead front 200. The cowl top panel is a resin member, is disposed on the vehicle front side of the windshield FG, and is formed into a tray shape recessed to a vehicle lower side.

Additionally, the bulkhead front 200 includes slants SL that are inclined from a vehicle-widthwise central part and the vehicle-widthwise outer side toward the drainage port DR1.

### Strut Towers 300

The strut towers 300 are each a vehicle-body-side support to which the suspension is to be attached, and are provided at vehicle-widthwise opposite sides on the vehicle front side of the toe board 100. Each of the strut towers 300 is a framework having a slant from an upper outer side in the vehicle width direction toward a vehicle lower inner side, and is formed of a metal or the like having high rigidity. The strut tower 300 is joined, on its vehicle upper outer side, to the frame structure 20.

The strut tower 300 is constituted by members joined to each other, and includes a top mount 310, a bracket front suspension lower 320, a reinforcement suspension front 330, and a reinforcement suspension side 340.

The top mount 310 is formed of a member such as a steel plate having high rigidity and forms a vehicle upper part of the strut tower 300. The top mount 310 has, on its vehicle upper-side surface, a substantially circular through hole that allows a vehicle upper part of the front-wheel suspension to be supported therethrough and that is opened to penetrate the top mount 310 in the vehicle up-down direction. The top mount 310 is joined, on its vehicle-widthwise outer side, to the frame structure 20 by welding or the like.

The bracket front suspension lower 320 is formed of a member such as a steel plate having high rigidity, turns to a vehicle internal-front side from a vehicle-widthwise inner side of the strut tower 300, and extends in the vehicle up-down direction. The bracket front suspension lower 320 is joined, on its vehicle upper side, to the top mount 310 by welding or the like. The bracket front suspension lower 320 is joined, on its vehicle rear side, to the toe board 100 and the bulkhead front 200 by welding or the like.

The reinforcement suspension front 330 is a rigid wall that reinforces a vehicle-widthwise outer rigidity of the bracket front suspension lower 320 and extends in the vehicle up-down direction. The reinforcement suspension front 330 is formed of a member such as a steel plate having high rigidity. The reinforcement suspension front 330 is disposed on the vehicle rear side of the strut tower 300. The vehicle upper part of the reinforcement suspension front 330 is joined to the top mount 310. A vehicle up-down direction edge on a vehicle front inner side of the reinforcement suspension front 330 is joined to the bracket front suspension lower 320 by welding or the like. Additionally, a vehicle up-down direction edge and a vehicle-widthwise edge at a vehicle rear part of the reinforcement suspension front 330 are joined to the toe board 100 and the bulkhead front 200 by welding or the like.

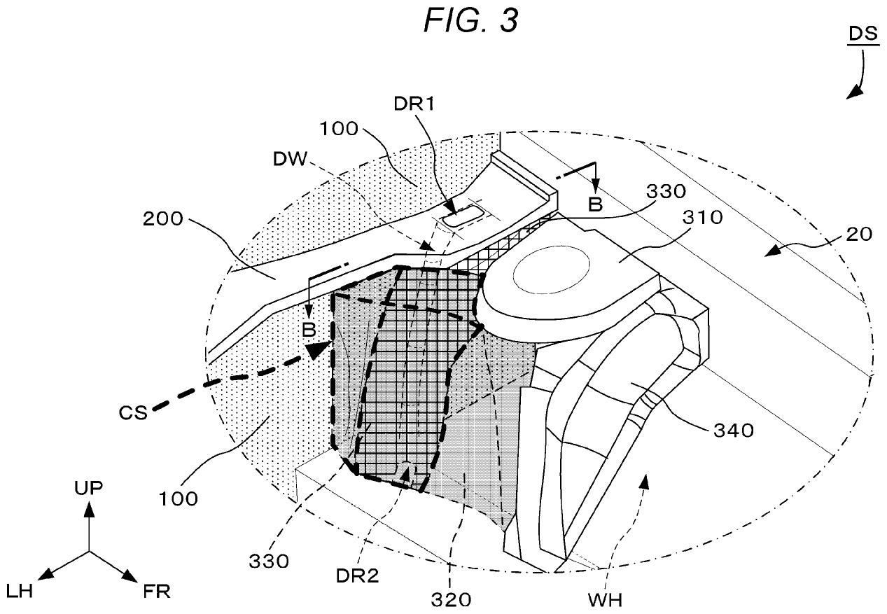

As illustrated in FIG. 3, for example, the reinforcement suspension front 330 has, on its vehicle upper-side surface, a drainage channel DW shaped to be recessed in the vehicle width direction as the drainage structure DS to be described later.

The reinforcement suspension side 340 is a rigid wall that reinforces a vehicle front-side rigidity of the bracket front suspension lower 320 and extends in the vehicle up-down direction. The reinforcement suspension side 340 is formed of a member such as a steel plate having high rigidity. The reinforcement suspension side 340 is disposed on the vehicle front side of the strut tower 300. The vehicle upper part of the reinforcement suspension side 340 is joined to the top mount 310. The reinforcement suspension side 340 is joined, on its vehicle-widthwise rear side, to the bracket front suspension lower 320 by welding or the like.

Furthermore, the bracket front suspension lower 320 and the reinforcement suspension side 340 close the vehicle-widthwise inner side and the vehicle front side, and the toe board 100 and the reinforcement suspension front 330 close the vehicle rear side. Thus, the inside of the vehicle-body front part FS is separated from the wheel house WH.

### Drainage Structure DS

As illustrated in FIG. 3, the drainage structure DS is constituted by the toe board 100 illustrated in dot-shaped hatching, the bulkhead front 200, the bracket front suspension lower 320 illustrated as a see-through view, and the reinforcement suspension front 330 illustrated in a grid-shaped hatching.

In one example, the drainage structure DS is constituted by the vehicle front-side surface of the toe board 100, the drainage port DR1 provided on the vehicle upper-side surface of the bulkhead front 200, the vehicle upper-side surface and the vehicle-widthwise inner-side surface of the bracket front suspension lower 320, the vehicle-widthwise inner-side surface of the reinforcement suspension front 330, the drainage port DR2, and the wheel house WH.

The drainage structure DS includes the closed cross section CS indicated by a thick broken line in FIG. 3. In one example, the closed cross section CS is provided as a space defined by the vehicle front-side surface of the toe board 100, the vehicle upper-side surface and the vehicle-widthwise inner-side surface of the bracket front suspension lower 320, and the vehicle upper-side surface and the vehicle-widthwise inner-side surface of the reinforcement suspension front 330.

Additionally, the drainage channel DW is provided inside the closed cross section CS. The drainage channel DW is provided as, for example, a recessed groove extending from the vehicle upper-side surface to the vehicle-widthwise inner-side surface of the reinforcement suspension front 330, and is formed into a substantially linear shape extending from the vehicle lower side of the drainage port DR1 toward the vehicle-widthwise inner side and then to the vehicle upper side of the drainage port DR2. Additionally, the closed cross section CS has no opening communicating with the inside of the engine room.

Additionally, the closed cross section CS has, on its vehicle lower side, the drainage port DR2 that penetrates the reinforcement suspension front 330 and is opened toward the wheel house WH. The drainage port DR2 is disposed at a position not overlapping the drainage port DR1 in a plan view, a front view, and a side view of the vehicle. Additionally, the drainage port DR2 has an opening area smaller than an opening area of the drainage port DR1.

### Operation and Effects

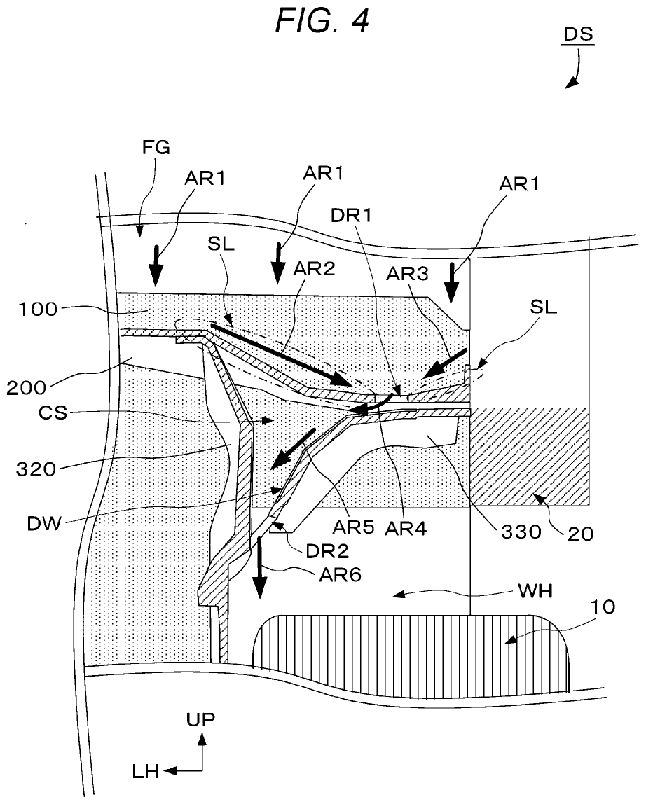

In the vehicle-body front structure S according to the present embodiment with the above configuration, with reference to FIGS. 4 to 6, a description will be given of a drainage effect and a rigidity reinforcement effect of the drainage structure DS.

The drainage structure DS includes the drainage port DR1, the closed cross section CS, the drainage channel DW, and the drainage port DR2.

### Drainage

When water droplets of rainwater and the like are applied to the windshield FG and the like and flow down to the vehicle front side, the rainwater and the like flow in a direction indicated by arrows AR1 as illustrated in FIG. 4.

The rainwater and the like flowing down along the windshield FG pass through the cowl top panel (not illustrated) and drop to the vehicle upper-side surface of the bulkhead front 200. Then, owing to the slants SL of the bulkhead front 200, the rainwater and the like dropped to the bulkhead front 200 flow toward the drainage port DR1 as indicated by arrows AR2 and AR3.

The rainwater and the like having reached the drainage port DR1 flow, as indicated by arrow AR4, toward the closed cross section CS provided on the vehicle lower side of the bulkhead front 200. Furthermore, the rainwater and the like flowing toward the closed cross section CS are guided to the drainage channel DW provided to extend in the vehicle width direction on the vehicle upper side of the reinforcement suspension front 330, flow down toward the vehicle lower side as indicated by arrows AR5 and AR6, and are discharged toward the wheel house WH through the drainage port DR2 provided in the vehicle lower part of the closed cross section CS.

### Water Entry Prevention

The drainage port DR2 is provided in the vehicle lower part of the closed cross section CS, thus preventing entry of water droplets of rainwater and the like through the drainage port DR2.

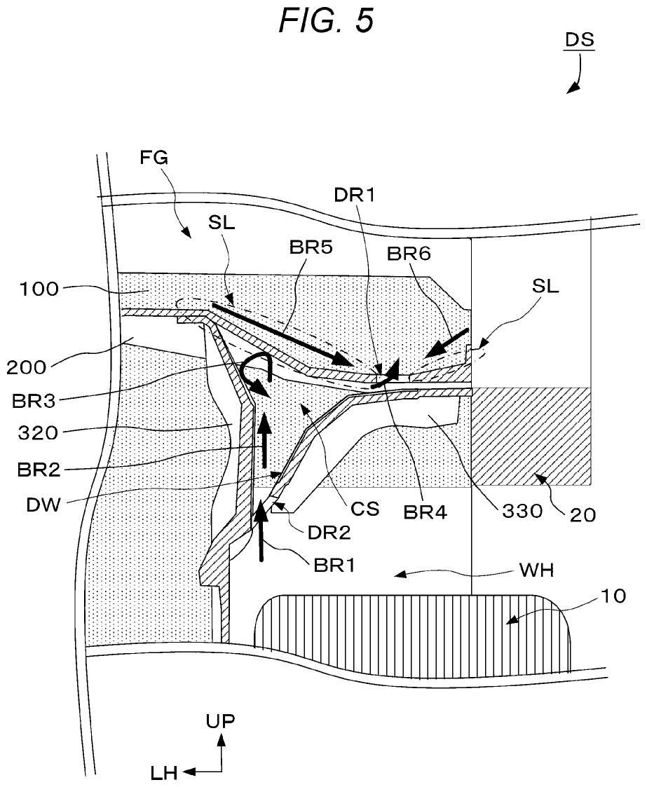

However, as illustrated in FIG. 5, when the vehicle V travels a place where a large amount of rainwater and the like are accumulated, the front wheel 10 stirs up the rainwater and the like into the wheel house WH, and the rainwater and the like flow backward through the drainage port DR2 as indicated by arrow BR1, the rainwater and the like flowing backward flow in a direction indicated by arrow BR2.

Here, the drainage port DR2 is disposed at the position not overlapping the drainage port DR1 in a plan view, a front view, and a side view of the vehicle. Additionally, the closed cross section CS is provided on the vehicle upper side of the drainage port DR2. Thus, the rainwater and the like flowing backward through the drainage port DR2 hit, as indicated by arrow BR3, the vehicle lower-side surface of the bulkhead front 200 on the vehicle upper side constituting the closed cross section CS, drop to the vehicle lower side, and are discharged through the drainage port DR2.

On the other hand, when the rainwater and the like flowing backward bounce back inside the closed cross section CS, flow backward in a direction indicated by arrow BR4, and are scattered through the drainage port DR1, owing to the slants SL of the bulkhead front 200, the rainwater and the like flowing backward flow again toward the drainage port DR1 as indicated by arrows BR5 and BR6. Then, the rainwater and the like flowing backward are discharged toward the wheel house WH through the drainage port DR2 provided in the vehicle lower part of the closed cross section CS.

Additionally, since the rainwater and the like flowing backward through the drainage port DR2 pass through the inside of the closed cross section CS, the rainwater and the like flowing backward are not scattered inside the engine room.

Additionally, by making the opening area of the drainage port DR2 smaller than the opening area of the drainage port DR1, the drainage port DR2 limits the amount of entry of rainwater and the like flowing backward from the wheel house WH, and restricts entry of small animals and the like into the drainage port DR2 through the wheel house WH.

### Rigidity Reinforcement

Upon occurrence of vibrations, twisting, noise, and the like associated with travel of the vehicle V and occurrence of collision and the like, the strut tower 300 is subjected to the transmission of loads oriented in various directions, such as collision energy. Thus, the strut tower 300 has a structure that can withstand a large load in order to improve steering stability, riding quality, safety, and the like of the vehicle, and the strut tower 300 is firmly joined to the frame structure 20.

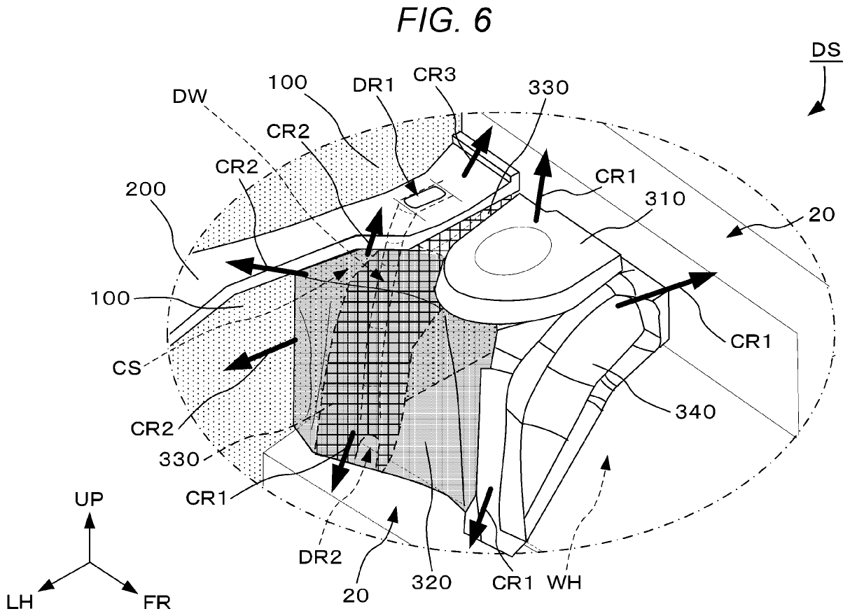

As illustrated in FIG. 6, the loads transmitted from the strut tower 300 are transmitted and distributed, as indicated by arrows CR1, to the frame structure 20 through the top mount 310, the bracket front suspension lower 320, the reinforcement suspension front 330, and the reinforcement suspension side 340. Furthermore, since the closed cross section CS is coupled to the toe board 100 and the bulkhead front 200, the loads transmitted from the strut tower 300 are transmitted and distributed, as indicated by arrows CR2, to the toe board 100 and the bulkhead front 200 through the bracket front suspension lower 320 and the reinforcement suspension side 340.

Additionally, the loads transmitted to the toe board 100 and the bulkhead front 200 are transmitted and distributed to the frame structure 20 as indicated by arrow CR3.

Additionally, the drainage channel DW provided in the reinforcement suspension front 330 provides a bead oriented in the vehicle up-down direction. Thus, the drainage channel DW increases the rigidity of the reinforcement suspension front 330.

Additionally, the drainage port DR1 and the drainage port DR2, which are openings, are weak areas in a rigidity reinforcement structure. Thus, by disposing the drainage port DR1 and the drainage port DR2, which are openings, at positions not overlapping each other, the weak areas due to the drainage structure DS are distributed.

As described above, the vehicle-body front structure S according to the present embodiment includes: the bulkhead front 200 that extends in the vehicle width direction, receives rainwater and the like from the windshield FG and the like, and guides the rainwater and the like to the outside in the vehicle width direction; the toe board 100 that extends in the vehicle width direction on the vehicle front side of the cabin CA serving as a passenger compartment and separates the cabin CA from the vehicle-body front part FS in which the front-wheel suspension and the like are accommodated; and the strut tower 300 that is constituted by members joined to each other and supports the front-wheel suspension. The bulkhead front 200 includes the vehicle-widthwise outer part having the drainage port DR1 as the first drainage port. The drainage port DR1 communicates with the drainage channel DW provided in the closed cross section CS defined by the bulkhead front 200, the toe board 100, and the members constituting the strut tower 300. The drainage channel DW has, on its vehicle lower side, the drainage port DR2 as a second drainage port opened toward the wheel house WH in which the tire is housed.

That is, the rainwater and the like flowing down along the windshield FG flow toward the drainage port DR1 owing to the slants SL of the bulkhead front 200. The rainwater and the like having reached the drainage port DR1 flow toward the closed cross section CS provided on the vehicle lower side of the bulkhead front 200. The rainwater and the like are guided to the drainage channel DW provided to extend in the vehicle width direction on the vehicle upper-side surface of the reinforcement suspension front 330, and flow down toward the vehicle lower side. Then, the drainage structure DS allows the rainwater and the like to be discharged toward the wheel house WH through the drainage port DR2 provided in the vehicle lower part of the closed cross section CS. Since the closed cross section CS has no opening communicating with the inside of the engine room, the rainwater and the like flowing backward are not scattered inside the engine room. This can prevent entry of water into the vehicle compartment through the vent hole.

Additionally, since the drainage port DR2 is provided in the vehicle lower part of the closed cross section CS, the drainage structure DS can prevent entry of rainwater and the like through the drainage port DR2. Additionally, since the closed cross section CS is defined by the bulkhead front 200, the toe board 100, and the members constituting the strut tower 300, the strut tower 300 can achieve high rigidity.

Thus, it is possible to achieve the drainage channel configuration maintaining the rigidity of the strut tower and prevent entry of rainwater and the like from the outside through the drainage channel.

Additionally, in the vehicle-body front structure S according to the present embodiment, the drainage port DR2 is disposed at the position not overlapping the drainage port DR1 in a plan view, a front view, and a side view of the vehicle V.

That is, since the drainage port DR2 is disposed at the position not overlapping the drainage port DR1, even when rainwater and the like stirred up by the tires flow backward through the wheel house WH, the rainwater and the like flowing backward through the drainage port DR2 hit the vehicle lower-side surface of the bulkhead front 200 on the vehicle upper side constituting the closed cross section CS and drop to the vehicle lower side. Then, the drainage structure DS allows the rainwater and the like flowing backward to be discharged through the drainage port DR2 without scattering of the rainwater and the like inside the engine room. Additionally, when the rainwater and the like flowing backward bounce back inside the closed cross section CS and are scattered through the drainage port DR1, owing to the slants SL of the bulkhead front 200, the rainwater and the like flowing backward flow again toward the drainage port DR1. Then, the drainage structure DS allows the rainwater and the like flowing backward to be discharged toward the wheel house WH through the drainage port DR2 provided in the vehicle lower part of the closed cross section CS.

Additionally, since the drainage port DR1 and the drainage port DR2, which are openings, are disposed at positions not overlapping each other, the drainage structure DS allows the weak areas to be distributed in the drainage structure DS.

Thus, it is possible to achieve the drainage channel configuration maintaining the rigidity of the strut tower and prevent entry of rainwater and the like from the outside through the drainage channel.

Additionally, in the vehicle-body front structure S according to the present embodiment, the drainage port DR2 has the opening area smaller than the opening area of the drainage port DR1.

That is, by making the opening area of the drainage port DR2 smaller than the opening area of the drainage port DR1, the amount of entry of the rainwater and the like flowing backward through the wheel house WH can be limited. Additionally, it is possible to restrict entry of small animals or the like into the drainage port DR2 through the wheel house WH. Additionally, by increasing the area of the rigidity reinforcement structure provided by the closed cross section CS, the strength of the rigidity reinforcement structure can be improved.

Thus, it is possible to achieve the drainage channel configuration maintaining the rigidity of the strut tower and prevent entry of rainwater and the like from the outside through the drainage channel.

Note that, as the embodiment of the disclosure, the example has been described that the drainage channel DW is provided, inside the closed cross section CS, as the recessed groove on the vehicle-widthwise inner-side surface of the reinforcement suspension front 330, and is formed into a substantially linear shape extending from the vehicle lower side of the drainage port DR1 toward the vehicle-widthwise inner side and then to the vehicle upper side of the drainage port DR2. However, the drainage channel DW may provide beads in order to enhance the rigidity of the reinforcement suspension front 330. Alternatively, on the vehicle-widthwise outer-side surface of the bracket front suspension lower 320, a bead may be provided as the drainage channel DW by being tilted toward the vehicle up-down direction or from the vehicle up-down direction toward the vehicle front-rear direction.

Although the embodiment of the disclosure has been described in detail with reference to the drawings, the specific configuration is not limited to the embodiment, and encompasses, for example, design variation within a scope not departing from the gist of the disclosure.

1. A vehicle-body front structure for a vehicle, the vehicle-body front structure comprising:
a bulkhead front that extends in a vehicle width direction of the vehicle, is configured to receive water droplets from a portion of the vehicle including a windshield of the vehicle, and is configured to guide the water droplets to an outside in the vehicle width direction;
a toe board that extends in the vehicle width direction on a vehicle front side of a vehicle compartment of the vehicle, and separates the vehicle compartment from a vehicle-body front part of the vehicle in which a front-wheel suspension is accommodated; and
a strut tower that is constituted by members joined to each other and configured to support the front-wheel suspension, wherein
the bulkhead front comprises a vehicle-widthwise outer part having a first drainage port,
the first drainage port communicates with a drainage channel provided in a closed cross section defined by the bulkhead front, the toe board, and the members constituting the strut tower, and
the drainage channel has, on a vehicle lower side of the drainage channel, a second drainage port opened toward a wheel house in which a tire is housed.

2. The vehicle-body front structure according to claim 1, wherein the second drainage port is disposed at a position not overlapping the first drainage port in a plan view, a front view, and a side view of the vehicle.

3. The vehicle-body front structure according to claim 1, wherein the second drainage port has an opening area smaller than an opening area of the first drainage port.

4. The vehicle-body front structure according to claim 2, wherein the second drainage port has an opening area smaller than an opening area of the first drainage port.
